(19) United States
(12) Patent Application Publication
(10) Pub. No.: US 2025/0066928 A1
(43) Pub. Date: Feb. 27, 2025

(54) ATOMIC HYDROGEN PROVISION BY COBALT SITES IN CATALYST CONFIGURATIONS FOR AMMONIA PRODUCTION

(71) Applicants: Sergio Garcia-Segura, Tempe, AZ (US); Gabriel Cerron Calle, Tempe, AZ (US)

(72) Inventors: Sergio Garcia-Segura, Tempe, AZ (US); Gabriel Cerron Calle, Tempe, AZ (US)

(21) Appl. No.: 18/810,776

(22) Filed: Aug. 21, 2024

Related U.S. Application Data
(60) Provisional application No. 63/578,038, filed on Aug. 22, 2023.

(51) Int. Cl. C25B 1/27; B01J 23/72; B01J 23/75; B01J 23/755; B01J 37/34; C25B 11/077

(52) U.S. Cl. CPC C25B 1/27; B01J 23/72; B01J 23/75; B01J 23/755; B01J 37/348; C25B 11/077; B01J 2523/17; B01J 2523/845; B01J 2523/847

(57) ABSTRACT

A composite catalyst includes a nickel foam and cobalt, copper, or both electrodeposited on the nickel foam. Making the composite catalyst includes contacting the nickel foam with an aqueous solution comprising copper, cobalt, or both, and electrodepositing nanodomains of copper, cobalt, or both, respectively, on the nickel foam. Electrochemically converting nitrate to ammonia includes contacting an electrode and a cathode comprising the composite catalyst in an electrochemical cell with an aqueous solution including nitrate, adsorbing the nitrate onto the copper, the cobalt, or both, reducing the nitrate to yield nitrite, and reducing the nitrite to yield ammonia.

### CROSS-REFERENCE TO RELATED APPLICATION

This application claims the benefit of U.S. Patent Application No. 63/578,038 filed on Aug. 22, 2023, which is incorporated by reference herein in its entirety.

### STATEMENT OF GOVERNMENT INTEREST

This invention was made with government support under 1449500 awarded by the National Science Foundation. The government has certain rights in the invention.

### TECHNICAL FIELD

This invention relates to catalysts for electrocatalytic conversion of nitrate into ammonia.

### BACKGROUND

The industrial synthesis of ammonia typically relies on the Haber-Bosch (HB) process which employs hydrogen and nitrogen as reagents under high pressure and high temperature. An iron-based catalyst can be used to enable the HB reaction to convert hydrogen and nitrogen into ammonia at lower temperatures. The HB process generates millions of tons of CO₂ annually, producing an extensive carbon footprint.

### SUMMARY

The present disclosure describes bimetallic and trimetallic composite catalyst systems for electrochemical conversion of nitrate to ammonia with compositions of Ni/Co(OH)ₓ and Ni/Cu₂O/Co(OH)ₓ, respectively. The catalyst systems are assembled by electrochemically depositing Co or Co/Cu on nickel foam. Ni/Cu₂O/Co(OH)ₓ enables ammonia production from nitrate feedstock. Cyclic voltammetry and scavenger tests show the capability of Co(OH)ₓ to provide atomic hydrogen and the impact of atomic hydrogen on ammonia production. Ni and Cu sites serve as nitrate adsorption sites and promote the reduction of nitrate to nitrite. Co(OH)ₓ nanocomposites promote the formation of ammonia by hybridized catalytic hydrogenation. Stability tests show high activity retention and safe metal leaching after 12 hours of continuous use.

In a first general aspect, a composite catalyst includes nickel foam and cobalt electrodeposited on the nickel foam, or copper electrodeposited on the nickel foam, or cobalt and copper electrodeposited on the nickel foam.

Implementations of the first general aspect may include one or more of the following features.

In some cases, the cobalt is electrodeposited on the nickel foam, and is present as cobalt hydroxide nanoparticles. The cobalt hydroxide nanoparticles typically have an average size between about 50 nm and about 100 nm. The composite catalyst typically includes about 1 wt % to about 10 wt % cobalt. In certain cases, the copper is electrodeposited on the nickel foam, and the copper is present as copper oxide nanoparticles. The copper oxide nanoparticles typically have an average size between about 500 nm and about 1000 nm. The composite catalyst typically includes about 1 wt % to about 10 wt % copper.

In some cases, the cobalt is electrodeposited on the nickel foam and the copper is electrodeposited on the nickel foam. The cobalt is typically present as a cobalt hydroxide and the copper is typically present as a copper oxide. The composite catalyst typically includes about 1 wt % to about 10 wt % cobalt and about 1 wt % to about 10 wt % copper. At least some of the cobalt hydroxide nanoparticles are grown over some of the copper oxide nanoparticles. The composite catalyst typically includes about 85 wt % to about 95 wt % nickel.

In some cases, making the composite catalyst includes contacting the nickel foam with an aqueous solution typically including copper, cobalt, or both, and electrodepositing nanodomains of copper, cobalt, or both respectively, on the nickel foam. The electrodeposition is conducted by chronoamperometry. The chronoamperometry is typically conducted for a length of time between 1 minute and 5 minutes.

In a second general aspect, electrochemically converting nitrate to ammonia includes contacting an electrode and a cathode in an electrochemical cell with an aqueous solution including nitrate, adsorbing the nitrate onto the copper, the cobalt, or both, reducing the nitrate to yield nitrite, and reducing the nitrite to yield the ammonia. The cathode includes the composite catalyst. The cobalt and the copper are electrodeposited on the nickel foam.

Implementations of the second general aspect may include one or more of the following features.

In some implementations, the conversion of nitrate exceeds 80% or 90%. In some cases, a concentration of the nitrate in the aqueous solution is in a range of about 30 mg L⁻¹ NO₃⁻N to about 200 mg L⁻¹ NO₃⁻N. In some examples, reducing the nitrate includes galvanostatically reducing the nitrate. Reducing the nitrate typically includes catalytic hydrogenating the nitrite.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1D show high-resolution x-ray photoelectron spectroscopy (XPS) analysis for Ni 2p, Cu 2p, Co 2p, and O 1s, respectively, in Ni/Cu₂O/Co(OH)ₓ.

FIGS. 2A-2D show linear sweep voltammetry (LSV) at a scan rate of 10 mV s⁻¹ in 12.5 mmol L⁻¹ Na₂SO₄ in the presence or absence of 2.0 mmol L⁻¹ NaNO₃ for the following electrode configurations: Ni foam, Ni/Cu₂O, Ni/Cu₂O/Co(OH)ₓ, and Ni/Cu₂O/Co(OH)ₓ, respectively. Current density was corrected using the calculated ECSA.

FIGS. 3A and 3B show cyclic voltammetry (CV) and nitrate removal (C/C₀) of nitrate electrolysis, respectively, using Ni/Co(OH)ₓ. FIG. 3A shows CV at 10 mV s⁻¹ of Ni/Co(OH)ₓ in 0.1 mol L⁻¹ NaOH with different cathodic potential limits (0.12, −0.07, and −0.27 V vs RHE). FIG. 3B shows C/C₀ of nitrate electrolysis using Ni/Co(OH)ₓ under 40 mA cm⁻² without and with different tert-butyl alcohol (TBA) concentrations.

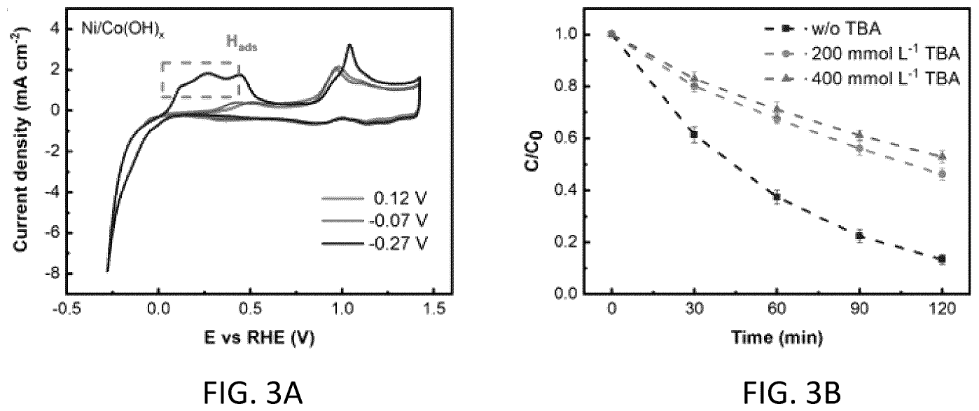

FIGS. 4A and 4B show CV and C/C0 of nitrate electrolysis, respectively, using Ni/Cu₂O/Co(OH)ₓ. FIG. 4A shows comparison between CVs of Ni/Cu₂O and Ni/Cu₂O/Co(OH)ₓ at mV s⁻¹ in 0.1 mol L⁻¹ NaOH. FIG. 4B shows C/C₀ of nitrate electrolysis using Ni/Cu₂O/Co(OH)ₓ under 40 mA cm⁻² without and with different TBA concentration (200 and 400 mmol L⁻¹).

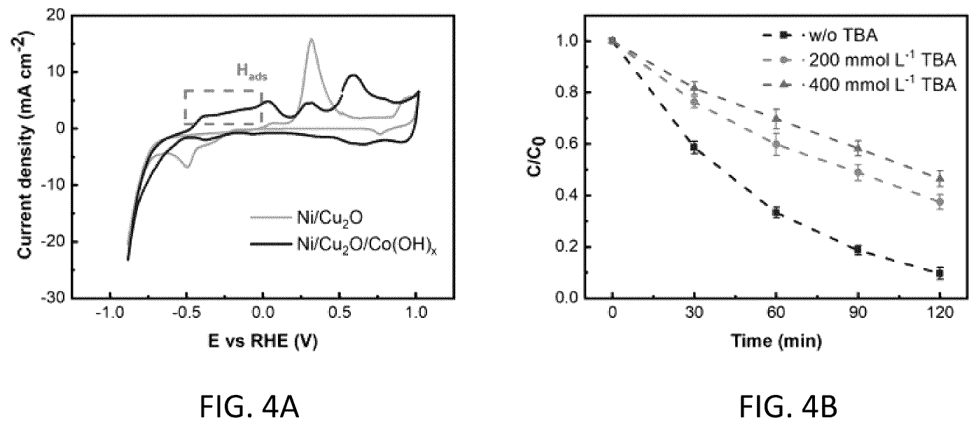

FIGS. 5A and 5B show ammonia yield and faradaic efficiency (FE) for different electrode configurations and ammonia concentration (mg L⁻¹ NH₃—N) and FE after 2 h of treatment at different current density, respectively.

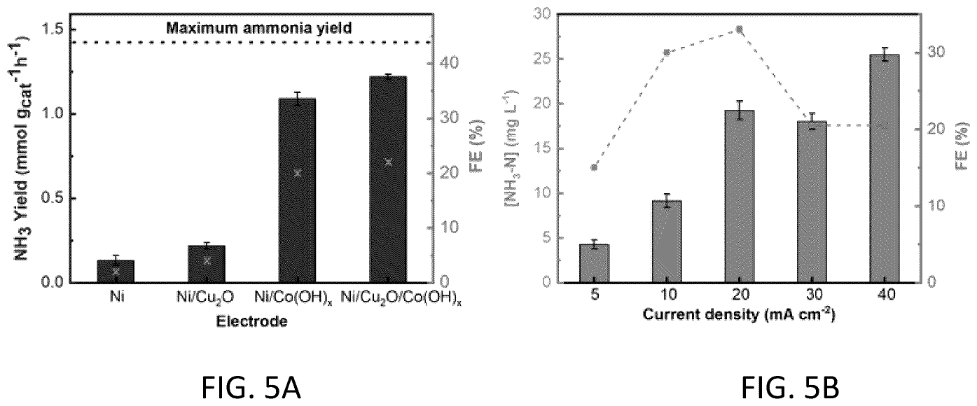

FIG. 6 shows ammonia production (mg L⁻¹ NH₃—N) after 2 h of treatment per cycle using Ni/Co(OH)ₓ and Ni/Cu₂O/Co(OH)ₓ configurations.

FIG. 7 shows accumulated metal leaching of Ni, Cu, and Co after 6 cycles of continuous use.

### DETAILED DESCRIPTION

Nitrogen gas (N₂) has been evaluated as a nitrogen source for electrochemical ammonia production. Electrochemical reduction of N₂ presents several drawbacks such as low solubility, high energy barrier due at least in part to the triple bond (N≡N, 941 kJ mol⁻¹), and competitive reactions. Nitrate (NO₃⁻) is an oxyanion present in groundwater. Concentrations above the regulated maximum contaminant levels (MCL) of 10 mg L⁻¹ for NO₃⁻—N are found in various water resources. Implementation of the electrochemical reduction of nitrate (ERN) to produce ammonia can address environmental pollution while producing an added-value product under mild conditions with less carbon footprint. The ERN can become a decentralized ammonia production system, alleviating needs at small and even medium scale production. The ERN process can be coupled with renewable energy systems and can enable fossil-free ammonia production off-grid.

The present disclosure describes bimetallic and trimetallic composite catalyst systems for electrochemical conversion of nitrate to ammonia with compositions of Ni/Co(OH)ₓ and Ni/Cu₂O/Co(OH)ₓ, respectively. The catalyst systems are assembled by electrochemically depositing Co or Co/Cu on nickel foam. Ni/Cu₂O/Co(OH)ₓ enables ammonia production from nitrate feedstock.

Composite catalysts described herein include nickel foam, with cobalt electrodeposited on the nickel foam, copper electrodeposited on the nickel foam, or cobalt and copper electrodeposited on the nickel foam. Nickel foam is a porous, metallic, three-dimensional network of interconnected nickel strands. The composite catalyst can include about 85 wt % to about 95 wt % nickel.

For a composite catalyst that includes cobalt, the cobalt is electrodeposited on the nickel foam, and is present as cobalt hydroxide nanoparticles. The cobalt hydroxide nanoparticles have an average size (e.g., average diameter) between about 50 nm and about 100 nm. In one example, a composite catalyst that includes cobalt has about 1 wt % to about 10 wt % cobalt.

For a composite catalyst that includes copper, the copper is electrodeposited on the nickel foam, and is present as copper oxide nanoparticles. The copper oxide nanoparticles have an average size between about 500 nm and about 1000 nm. In one example, a composite catalyst that includes copper has about 1 wt % to about 10 wt % copper.

For a composite catalyst that includes cobalt and copper, the cobalt and copper are electrodeposited on the nickel foam, with the cobalt present as a cobalt hydroxide and the copper present as a copper oxide. In one example, a composite catalyst that includes cobalt and copper has, independently, about 1 wt % to about 10 wt % cobalt and about 1 wt % to about 10 wt % copper. In one example, at least some of the cobalt hydroxide nanoparticles are grown (e.g., electrodeposited) over some of the copper oxide nanoparticles.

Making the composite catalyst can include contacting nickel foam with an aqueous solution comprising copper, cobalt, or both, and electrodepositing nanodomains of copper, cobalt, or both respectively, on the nickel foam. As used herein, a “nanodomain” generally refers to atoms assembled or clustered together to form a region having a dimension in a range of about 1 nm to about 1000 nm, or about 1 nm to about 100 nm. The electrodeposition can be conducted by chronoamperometry (e.g., for a length of time between about 1 minute and about 5 minutes).

As described herein, electrochemically converting nitrate to ammonia includes contacting an electrode and a cathode in an electrochemical cell with an aqueous solution that includes nitrate. The cathode includes the composite as described herein. In some examples, a concentration of the nitrate in the aqueous solution is in a range of about 30 mg L⁻¹ NO₃⁻—N to about 200 mg L⁻¹ NO₃⁻—N. The nitrate is adsorbed onto the copper, the cobalt, or both, and the nitrate is reduced to yield nitrite. The nitrate can be reduced galvanostatically or by catalytic hydrogenation. The nitrite is reduced to yield the ammonia. The conversion of nitrate can exceed 80% or 90%.

### EXAMPLES

Materials and Methods. All reagents were of analytical grade and were acquired from Sigma-Millipore. Nickel foam was used as a substrate and was obtained from Futt (99% purity and 110 pores per inch). Nano-enabled Cu composites were prepared using anhydrous CuSO₄ (≥99%); while Co composites were prepared using Co(SO₄)·5H₂O (≥99%), H₃BO₃ (≥99.5%), and Na₂SO₄ (≥99%). The N-species solutions were obtained from NaNO₃ (≥99%), NaNO₂ (≥97%), and (NH₄)₂SO₄ (≥99%) salts. Na₂SO₄ (≥99%) or NaOH (≥97%) were used as the electrolyte during electrochemical experiments. Tert-butyl alcohol (≥99%) was used as an atomic hydrogen scavenger. All solutions were prepared with ultrapure water supplied by Elga Lab Water (>18 MΩ cm at 25° C.).

Electrodeposition of Cu and Co(OH)ₓ nanocomposites. Nickel foam modification was carried out by chronoamperometry using a potentiostat PGSTAT302 from Metrohm (USA). The Ni foam electrode was cleaned for 15 min before modification using an ultrasonic bath in acetone to remove organic components on the metal surface. The Ni foam electrode was soaked with 1.0 mol L⁻¹ HCl solution for 5 min to remove the superficial oxide layer. The electrodes were thoroughly rinsed with ultrapure water and dried at room temperature (25±2° C.). Chronoamperometry was performed in a three-electrode configuration using a platinum plate as the counter-electrode, Ag/AgCl (3.0 mol L⁻¹ KCl) as the reference electrode, and Ni foam (1.5×1.5 cm²) as the working electrode.

Electrodeposition conditions for copper nanocomposites were determined by cyclic voltammetry (CV) using Ni foam in a 10 mmol L⁻¹ CuSO₄ precursor solution. An electrodeposition potential of −0.6 V vs Ag/AgCl was identified as a suitable condition from the CV profile. The electrodeposition of Cu nanodomains was performed by chronoamperometry at −0.6 V vs Ag/AgCl for varying lengths of time (60 s, 120 s, and 180 s). Electrodeposition of cobalt nanocomposites was evaluated by CV of Ni foam in precursor solution containing 5 mmol L⁻¹ Co(SO₄)·5H₂O, 0.5 mol L⁻¹ H₃BO₃, and 0.5 mol L⁻¹ Na₂SO₄. The CV showed that Co electrodeposition potential was established at −1.2 V vs Ag/AgCl. The electrodeposition of Co was conducted by chronoamperometry at −1.2 V vs Ag/AgCl for varying lengths of time (120 s, 180 s, and 240 s). After electrodeposition, electrodes were rinsed with ultrapure water and dried at room temperature to register their mass. Each electrode is referenced herein using the components and electrodeposition time (e.g., Ni/Cu₂O 120 s, Ni/Co(OH)ₓ 180 s).

Electrochemical characterization. Electrochemical surface area (ECSA) was evaluated by CV using a 0.1 V potential window in 0.5 mol L⁻¹ Na₂SO₄ at different scan rates (5, 10, 25, 50, and 75 mV s⁻¹). Redox behavior was evaluated by CV of Ni, Ni/Cu₂O, Ni/Co(OH)ₓ, and Ni/Cu₂O/Co(OH)ₓ in 0.5 mol L⁻¹ Na₂SO₄ solution at 50 mV s⁻¹ using different potential range according to electrode configuration. Atomic hydrogen adsorption evaluation was performed by CV in 1.0 M NaOH in similar cell configuration while using Hg/HgO (1.0 mol L⁻¹ NaOH) as the reference electrode. Electrochemical nitrate and nitrite reduction were evaluated by linear sweep voltammetry (LSV) at 25 mV s⁻¹ in 12.5 mmol L⁻¹ Na₂SO₄ and 30 mg L⁻¹ nitrogen containing solution (e.g., NaNO₃ or NaNO₂) replicating the electrolyte concentration used in the galvanostatic experiments to evaluate the electrode performance. All solutions were purged with N₂ (99%, provided by ASU gases) before electrochemical measurements, and potentials were adjusted to reference hydrogen electrode (RHE) to facilitate comparisons using the following Equation (1) and Equation (2).

$$E ( RHE ) = {E}_{Ag / AgCl} + 0.059 pH + {E}_{Ag / AgCl}^{*} \qquad ( 1 )$$

$$E ( RHE ) = {E}_{Hg / HgO} + 0.059 pH + {E}_{Hg / HgO}^{*} \qquad ( 2 )$$

where E°_{Ag/AgCl} and E°_{Hg/HgO} are 197 mV and 98 mV at 25° C., respectively. Current density was re-calculated using the ECSA obtained for each configuration for a better intrinsic activity comparison.

Galvanostatic nitrate reduction. Electrocatalytic nitrate reduction experiments were conducted in galvanostatic mode applying 40 mA cm⁻² using a power supply (TENMA 72-2720 DC) in an open cylindrical batch reactor. A parallel electrode configuration was used with 1.0 cm between each electrode. A dimensionally stable anode of Ti/IrO₂ (DSA) provided by DeNora was used as the anode. The different prepared electrodes were used as the cathode. Nitrate solution concentrations of 30 mg L⁻¹ NO₃⁻—N were used as an environmentally-relevant model, since the concentration corresponds to nitrate concentrations typically found in groundwater sources. A 100 mL volume of non-aerated 30 mg L⁻¹ NO₃⁻—N with 12.5 mmol L⁻¹ Na₂SO₄ solution was treated for 2 h while continuously stirring at 500 rpm. Solution conductivity and pH were recorded during the experiment. Samples were withdrawn at 0, 15, 30, 60, 90, and 120 min to evaluate N-species (NO₃⁻, NO₂⁻, and NH₃). The NO₂⁻ and NH₃ re-oxidation were evaluated using similar electrical conditions in 30 mg L⁻¹ of NO₂⁻ and NH₄⁺, respectively. All experiments were conducted in triplicate and error bars show the 95% confidence interval.

Material characterization. Crystallographic composition was evaluated by X-ray diffraction (XRD) using a PANanalytical Aeris diffractometer with Cu Kα radiation source (45 kV and 30 mA) from 20° to 80°. X-ray photoelectron spectroscopy (XPS, Kratos Axis Supra+) was used to identify the oxidation state of the elements using wide and high-resolution energy scan. The crystallographic structure of copper and cobalt nanocomposites was evaluated on an aberration-corrected (scanning) transmission electron microscope (STEM) (JEM-ARM200F) with a nominal resolution of 0.08 nm. Prior to STEM examination, the bimetallic electrodes were ultrasonically dispersed in ethanol and a drop of the solution was cast onto a lacey-carbon coated TEM grid. Morphological characterization was evaluated using field emission scanning electron microscope (FE-SEM) Auriga, Zeiss. The FE-SEM images were recorded at 5 keV and 1.6 nA using an in-lens detector. Elemental mapping was registered by energy dispersive X-ray spectroscopy (EDS) coupled to the FE-SEM. The EDS mapping images were recorded at 20 keV with a working distance of 10.5 mm. Metal leaching (e.g., Ni, Cu, and Co) from the electrode was determined by inductively coupled plasma-mass spectrometry (ICP-MS, Perkin Elmer) at the end of each 2 h cycle, repeated six times for a total of 12 h.

Analytical instruments and calculations. Solution conductivity and pH were recorded using Thermo Scientific Orion Star A221meters. All N-species were quantified with a HACH DR6000 UV-Vis spectrophotometer using HACH kits TNT 835 (λ=345 nm), TNT 839 (λ=515 nm), and TNT 830 (λ=694) to determine NO₃⁻, NO₂⁻, and NH₃, respectively. Nitrate conversion was calculated using initial nitrate concentration, [NO₃⁻]₀, and nitrate concentration at time t, [NO₃⁻]ₜ, according to the Equation (3):

$$Nitrate conversion ( \% ) = \frac{{[ {NO}_{3}^{-} ]}_{0} - {[ {NO}_{3}^{-} ]}_{t}}{{[ {NO}_{3}^{-} ]}_{0}} \times 100 \qquad ( 3 )$$

N-species mass balance was determined using concentrations of NO₃⁻, NO₂⁻, and NH₃ subtracted from the initial nitrogen content (30 mg L⁻¹). Residual N-species were considered as N-gas species without further compound identification since NH₃ was the desired compound. The nitrate conversion rate constant (k₁) was calculated following a pseudo-first order reaction using time (t), initial nitrate concentration, [NO₃⁻]₀, and nitrate concentration at time t, [NO₃⁻]ₜ, according to the Equation (4):

$${ln [ {NO}_{3}^{-} ]}_{t} = - kt + {ln [ {NO}_{3}^{-} ]}_{0} \qquad ( 4 )$$

Selectivity towards ammonia (S_{NH3}) was determined after treatment using the ammonia concentration, [NH₃], and nitrate variation ([NO₃⁻]₀−[NO₃⁻]ₜ) following Equation (5):

$${S}_{( {NH}_{3} )} ( \% ) = \frac{[ {NH}_{3} ]}{{[ {NO}_{3}^{-} ]}_{0} - {[ {NO}_{3}^{-} ]}_{t}} \times 1. \qquad ( 5 )$$

Ammonia yield (Y_{NH3}) was calculated from ammonia concentration [NH₃], chamber volume (V), electrode mass (m_{cat}) and the time (1) according to the Equation 6:

$${Y}_{{NH}_{3}} = \frac{[ {NH}_{3} ] V}{{m}_{cat} t} \qquad ( 6 )$$

The Faradaic efficiency (FE) was calculated by Faraday's law where n is the number of electrons required per mol of ammonia, F is the Faradaic constant (96,485 C mol⁻¹), N is the number of moles produced by electrolysis, t is the time (h), I is the applied current (A), and 3600 is a unit conversion factor (3600 s h⁻¹) according to the Equation 7

$$FE ( \% ) = \frac{nFN}{3600 It} \times 100 \qquad ( 7 )$$

Electrical energy per order was estimated using Equation (8) where E_{cell} is the cell potential (V), I is the current density (A), t is the time (h), V is the chamber volume (L), [NO₃⁻]₀ is the initial nitrate concentration and [NO₃⁻]ₜ is the nitrate concentration at time t

$$EE / O ( kWh {m}^{- 3} {order}^{- 1} ) = \frac{{E}_{cell} It}{V log ( {[ {NO}_{3}^{-} ]}_{0} {/ [ {NO}_{3}^{-} ]}_{t} )} \qquad ( 8 )$$

Structural and morphological characterization of three-dimensional nano-enabled electrodes. Crystallographic properties of Cu and Co nanocomposites on Ni foam was evaluated by scanning transmission electron microscope (STEM). The high-angle annular dark field (HAADF) of copper nanocomposites after sonication of the bimetallic electrode Ni/Cu₂O was obtained. The bright field (BF) image showed an interplanar distance of 0.30 nm which corresponds to the plane (110) of Cu₂O. The BF image suggests the presence of a Cu₂O layer after the electrode contacted the ambient air. The HAADF image of cobalt nanocomposites after sonication of the bimetallic electrode Ni/Co(OH)ₓ was obtained. The BF image showed an interplanar distance of 0.27 nm which corresponds to the plane (010) in Co(OH)₂. The ternary configuration of Ni/Cu2O/Co(OH)ₓ was characterized by HAADF and BF images in order to identify each crystallographic phase. The presence of Cu₂O and Co(OH)ₓ was confirmed. The Cu₂O structure contained an interplanar distance of 0.30 nm and the Co(OH)ₓ structure contained interplanar distances of 0.27 and 0.22 nm which corresponds to plane (010) of Co(OH)₂ and plane (012) of CoOOH phases, respectively. Bimetallic and trimetallic configurations include the presence of metal oxides on the surface due at least in part to the interaction with oxygen in the air.

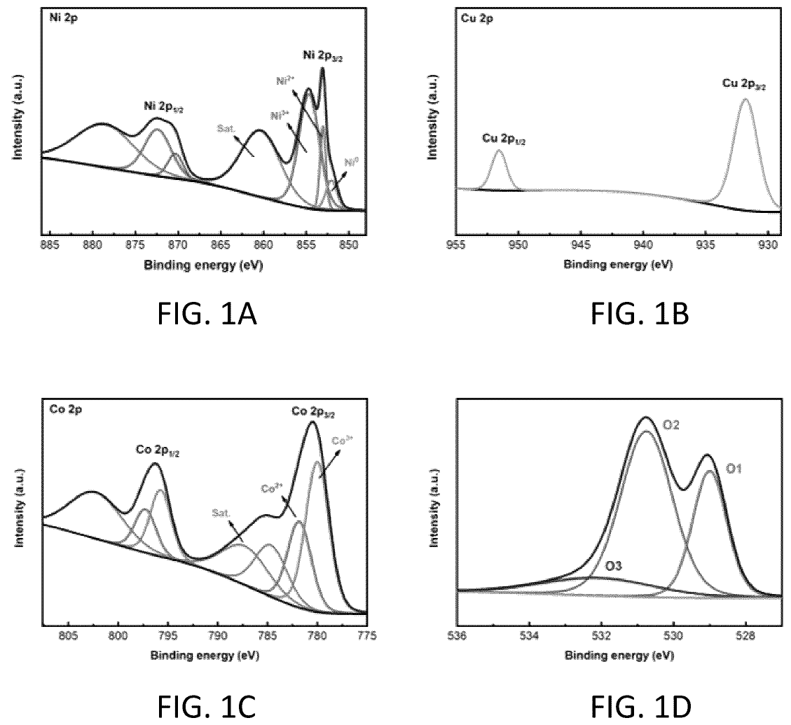

X-ray photoelectron spectroscopy (XPS) was performed to evaluate the chemical oxidation states and the elemental composition on the electrodes' surface. The XPS data showed the presence of Ni, Cu, Co, O, and C in different nano-enabled electrodes. High-resolution XPS analysis of bare Ni foam for Ni 2p showed the coexistence of a complex configuration at the surface of Ni foam due at least in part to the presence of Ni⁰, Ni²⁺, and Ni³⁺. After foam pre-treatment, nickel reacted with oxygen generating hydroxides, oxides, or a mixture of thereof. The O 1s spectrum showed the presence of lattice oxygen, vacancy oxygen, and oxygen from organic compounds, which correlates with the nickel compounds observed in the high-resolution XPS analysis. The high-resolution spectra of Ni/Cu₂O for Cu 2p shows the presence of Cu²⁺ and Cu¹⁺/Cu⁰, while STEM data support the existence of Cu¹⁺ in the crystal structure of Cu₂O. XPS analyses of Ni/Co(OH)ₓ for Co 2p shows the coexistence of Co²⁺ and Co³⁺ as observed in the STEM data of Co(OH)₂ and CoOOH, respectively. FIG. 1A depicts the high-resolution spectrum for Ni 2p in the Ni/Cu2O/Co(OH)ₓ electrode that can be deconvoluted in two-spin orbit coupling levels for Ni 2p_{3/2} (850.0-857.4 eV) and Ni 2p_{1/2} (867.7-1099.8 eV) states and two shake-up satellites around 860.3 and 878.7 eV. The three fitted peaks for Ni 2p_{3/2} correspond to Ni⁰ at 852.0 eV, Ni²⁺ at 853.1 eV, and Ni³⁺ around 854.7 eV. The two peaks for Ni 2p_{1/2} were assigned to Ni²⁺ and Ni³⁺ at 870.3 and 872.4 eV, respectively. Nickel oxides were present on the electrode surface due at least in part to the atmospheric oxygen exposure. FIG. 1B shows the high resolution XPS of Cu 2p where two peaks are identified corresponding to Cu 2p_{3/2} and Cu 2p_{1/2} at 931.8 and 951.5 eV, respectively. The two peaks can be assigned to Cu⁰ or Cu⁺¹ oxidation states because the difference between them is around 0.3 eV. The Co 2p spectrum depicted in FIG. 1C shows the Co 2p_{3/2} (775.0-783.8 eV) and Co 2p_{1/2} (792.8-799.3 eV) states and two shake-up satellites around 785.2 and 802.0 eV. The peaks appearing at 780.0 and 795.8 eV correspond to Co³⁺ and peaks around 781.9 and 797.3 eV are attributed to Co²⁺. The Co³⁺ and Co²⁺ oxidation states correspond to Co(OH)ₓ due at least in part to the oxidation of cobalt when exposed to air. The O 1s spectrum depicted in FIG. 1D presents three peaks at 529.8, 530.9, and 532.0 eV corresponding to O1, O2, and O3, respectively. The O1 is related to an oxygen-metal bond, O2 is assigned as an oxygen vacancy or hydroxide configuration, and O3 is attributed to chemisorbed oxygen.

Field emission-scanning electron microscope (FE-SEM) images showed the morphology of bare Ni foam and a modified electrode. The Ni foam presented a smooth surface without particles but showed average surface craters of 550±180 nm that can promote nucleation and growth of nanoparticles. The bimetallic electrode Ni/Cu₂O presented particles on the Ni surface with an average size of 644±125 nm that were preferentially nucleated and grown in Ni foam crater. Cu₂O nanoparticles presented an asymmetrical shape with smooth edges and well-defined terrace facets. Spherical Co(OH)ₓ nanocomposites were grown uniformly presenting an average size of 86±10 nm. (OH)ₓ demonstrated a higher coverage at the edges and interstices of the Ni foam. The configuration of Ni/Cu₂O/Co(OH)ₓ showed a combination of the Ni/Cu₂O and Ni/Co(OH)ₓ morphologies where Cu₂O nanoparticles are larger than Co(OH)ₓ nanocomposites generating a complex morphology. Co(OH)ₓ domains grown over Cu₂O nanoparticles generate a characteristic roughness aspect observable on the surface when compared to facets presented in Ni/Cu₂O. The ternary electrode configuration of Ni/Cu₂O/Co(OH)ₓ showed a high coverage of Ni foam that may decrease the direct interfacial interaction of Ni with the species in an aqueous solution.

Energy dispersive X-ray spectroscopy was carried out to identify the elemental mapping of bare Ni foam, Ni/Cu₂O, and Ni/Co(OH)ₓ. The EDS mapping of Ni/Cu₂O/Co(OH)ₓ showed the distribution of Ni, Cu, and Co. An Ni signal was present as a background with dark shadows due at least in part to the presence of different thin material over the surface. The shadows correspond to Cu₂O particles according to the characteristic Cu signal obtained. The Co signal covered the surface. In Cu sites partial electrodeposition of Co(OH)ₓ over Cu₂O nanoparticles was shown. The percent weight composition (wt %) for Ni/Cu₂O/Co(OH)ₓ demonstrated a low weight superficial composition for Cu (5.1%) and Co (5.4%) with respect to Ni (88.9%). The weight composition of different electrode configurations is provided in Table 1.

TABLE 1
Elemental composition obtained by EDS mapping
of different electrode configurations

Elemental composition (%)

| Electrode | Ni | Cu | Co | C |
|---|---|---|---|---|
| Ni | 89.9 | — | — | 10.1 |
| Ni/Cu₂O | 91.3 | 5 | — | 3.7 |
| Ni/Co(OH)ₓ | 90.3 | — | 4.4 | 4.3 |
| Ni/Cu₂O/Co(OH)ₓ | 88.9 | 5.1 | 5.4 | 0.6 |

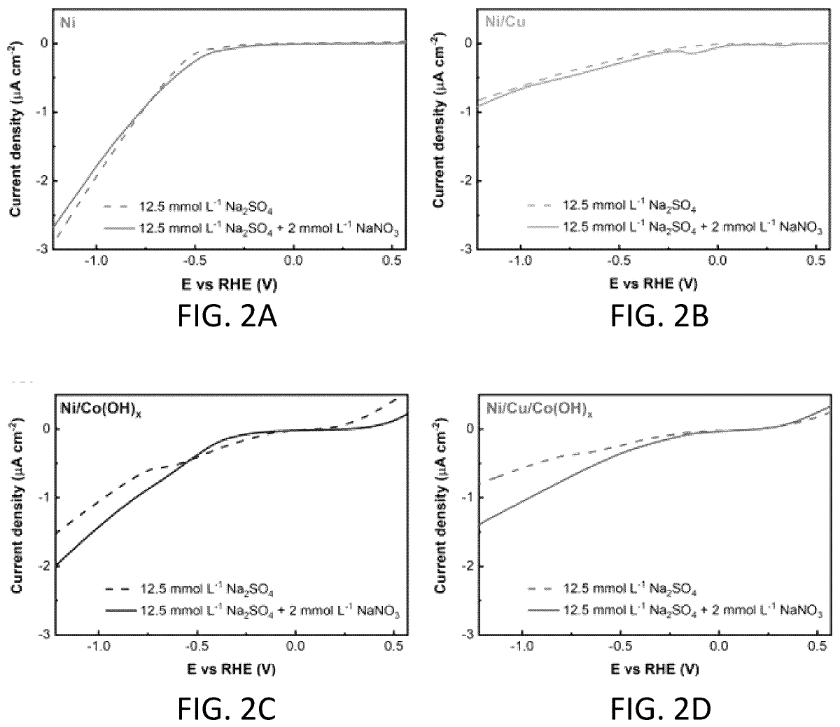

Performance of electrochemical nitrate reduction. Activity and product selectivity in heterogeneous catalysis can be controlled at least in part by the structural composition of the electrode surface. Electrodeposition conditions can influence the composition of electroactive materials. Cu₂O and Co(OH)ₓ coverage was defined by the electrodeposition time of given pulses of potential. The electrocatalytic impact on ERN of different electrosynthesized structures was evaluated considering nitrate removal and ammonia production. The nitrate removal (%) as a function of increasing electrodeposition time exhibited a “volcano” shape with a peak in nitrate removal (%) in the center and decreasing nitrate removal on the shorter and longer electrodeposition times. The shape of nitrate removal (%) as a function of electrodeposition time suggests regions of optimal electrodeposition times for enhanced conversion. A study of electrode optimization of Ni/Cu₂O/Co(OH)ₓ at different Cu and Co electrodeposition times for nitrate conversion (%) and ammonia production (mg L⁻¹) show the synergistic effects of trimetallic interface regions as a mechanism to improve transformation and selectivity of ERN. According to the experimental data, the optimal electrodeposition time for the trimetallic electrode Ni/Cu₂O/Co(OH)ₓ was observed for Cu₂O 120 s and Co(OH)ₓ 180 s. As observed with FE-SEM images, modification of Ni foam with Cu₂O and Co(OH)ₓ involves a change in the surface morphology. ECSA evaluation was helpful to distinguish the intrinsic material activity from the effects induced by an area increment. Electrochemical double-layer capacitance (C_{dl}) evaluation was performed to estimate the ECSA after each modification. Using data from plots of cyclic voltammetry at different scan rates of bare Ni foam, Ni/Cu₂O, Ni/Co(OH)ₓ, and Ni/Cu₂O/Co(OH)ₓ as a function of current intensity and a determination of double-layer capacitance by a linear fit of current as a function of scan rate), ECSA values were calculated obtaining 1913 cm² for Ni foam, 4838 cm² for Ni/Cu₂O, 2813 cm² for Ni/Co(OH)ₓ, and 3518 cm² for Ni/Cu₂O/Co(OH)ₓ as summarized in Table 2. The intrinsic activity of electrochemical nitrate reduction was investigated by LSV in 12.5 mmol L⁻¹ Na₂SO₄ in the presence or absence of 2 mmol NaNO₃ (30 mg L⁻¹ NO₃⁻—N). Current density was corrected using the ECSA calculated due at least in part to the difference between these values. As shown in FIG. 2A, Ni foam LSV presents similar current density in presence or absence of nitrate indicating their low intrinsic activity for nitrate reduction. The LSV profile for Ni/Cu₂O (FIG. 2B), Ni/Co(OH)ₓ (FIG. 2C), and Ni/Cu₂O/Co(OH)ₓ (FIG. 2D) presents different current density increments around 0.075, 0.47, and 0.60 μA cm⁻², respectively. Ni/Cu₂O/Co(OH)ₓ exhibited higher intrinsic activity for nitrate reduction than other configurations in terms of direct charge transfer.

TABLE 2
Electrochemical surface area calculated by specific capacitance
method of different electrode configurations

| | Ni | Ni/Cu₂O | Ni/Co(OH)ₓ | Ni/Cu₂O/Co(OH)ₓ |
|---|---|---|---|---|
| ECSA (cm²) | 1913 | 4838 | 2813 | 3518 |

The electrochemical nitrate reduction of different electrode configurations was evaluated under comparable conditions in galvanostatic mode applying 40 mA cm⁻². N-species conversion using Ni foam showed 9.6% of nitrate conversion, producing 0.12 mg L⁻¹ NO₂⁻—N and 2.78 mg L⁻¹ NH₃—N. Ni/Cu₂O configuration showed 28.4% nitrate removal, producing 4.70 mg L⁻¹ NO₂⁻—N and 4.56 mg L⁻¹ NH₃—N. The presence of Cu sites in the electrode surface can accelerate the conversion of nitrate to nitrite according to Equation (9). The nitrate to nitrite reaction is considered the rate limiting step of the overall ERN.

NO_{3(ads)}⁻+1e⁻→NO_{2(ads)}⁻ (9)

Nitrite can adsorb and poison catalytic sites of metallic copper. The loss of active sites can be a limitation for Cu based electrodes generating nitrite accumulation in solution. Nitrite accumulation can result in high concentrations after 2 h of treatment that exceed the maximum contamination level (MCL) of 1.0 mg L⁻¹ NO₂⁻—N. The Ni/Co(OH)ₓ configuration showed 86.7% of nitrate removal with ammonia concentration of 22.75 mg L⁻¹ NH₃—N and N-gas species 3.21 mg L⁻¹ as N. The Ni/Cu₂O/Co(OH)ₓ configuration showed 90.3% of nitrate removal, producing 25.5 mg L⁻¹ NH₃—N and 1.58 mg L⁻¹ N-gas species.

the pseudo-first order rate constants for nitrate conversion using Ni, Ni/Cu₂O, Ni/Co(OH)ₓ, and Ni/Cu₂O/Co(OH)ₓ were calculated, obtaining 6×10⁻⁴, 3×10⁻³, 1×10⁻², and 2×10⁻² min⁻¹, respectively. The presence of Co sites in Ni/Co(OH)ₓ and Ni/Cu₂O/Co(OH)ₓ configurations accelerated the production of ammonia without nitrite generation and promoted the increase of N-gas species. To investigate this behavior, each configuration was evaluated for reduction of 30 mg L⁻¹ NO₂⁻-N to identify intrinsic activity and kinetics. Pseudo-first order rate constants for NO₂⁻ reduction using Ni, Ni/Cu₂O, Ni/Co(OH)ₓ, and Ni/Cu₂O/Co(OH)ₓ were calculated, obtaining 1.6×10⁻², 1.3×10⁻², 5.6×10⁻² and 8.3×10⁻² min⁻¹, respectively. The lowest rate constant associated with Ni/Cu₂O suggests poisoning of the surface due at least in part to nitrite accumulation. The adsorption preference has a positive impact on the Ni/Cu₂O/Co(OH)ₓ presenting higher rate constant than Ni/Co(OH)ₓ. The larger surface concentration of nitrite adsorbed on copper sites can potentially be reduced by adsorbed hydrogen spillover.

The origin of higher loss of dissolved N-species was experimentally assessed through different blank experiments. Electro-oxidation of NH₄⁺ was evaluated. The evaluation of electro-oxidation of NH₄⁺ showed negligible oxidation that does not explain the decrease in ammonia concentration. The increment of N-gas may be explained by the relation between pH and NH₃ solubility in water. Solution pH values higher than 10 were recorded after 90 min of ERN treatment. At alkaline pH, the equilibrium of NH₄⁺/NH₃ moves towards NH₃ that at certain concentrations leaves the solution according to Henry's law (K_{H}=55.9 mol L⁻¹ atm⁻¹ at 25° C. Volatilization due at least in part to high pH was evaluated to demonstrate the ammonia decrease. An open system containing 30 mg L⁻¹ NH₃—N does not produce changes in N-content at approximately neutral pH, but more than 10 mg L⁻¹ NH₃—N can be volatilized when pH over 11 is reached.

Nitrate activity and NH3 selectivity of Ni—Cu—Co(OH)ₓ. Electrocatalysts were evaluated under environmentally relevant nitrate concentrations (e.g., 30-200 mg L⁻¹ NO₃⁻—N) and typical industrial concentrations (e.g., 1400-7000 mg L⁻¹ NO₃⁻—N). At environmentally relevant concentrations, the materials presented in this work have a increased yield. The Ni/Cu₂O/Co(OH)ₓ performance is higher than electrocatalysts tested at extremely high nitrate concentrations of 1400 mg L⁻¹ NO₃⁻—N. The electrocatalysts disclosed herein demonstrate the an increased performance that earth-abundant materials can reach using the correct combination and electrocatalyst design.

To gain an understanding of the ERN mechanism in the presence of Co(OH)ₓ, electrodes were evaluated in high alkaline conditions (1.0 mol L⁻¹ NaOH) to suppress the hydrogen evolution reaction (HER). CVs of Ni/Co(OH)ₓ were evaluated using different cathodic voltage limits (0.12, −0.07, and −0.27 V vs RHE) to evaluate the impact of the HER in the electrochemical behavior of the electrode. At 0.12 and −0.07 vs RHE, both CVs present a similar profile showing characteristic electrode peaks without any difference between the two samples. Using −0.27 vs RHE as negative limit, the HER occurred providing highly reactive atomic hydrogen (H_{ads}) in the electrode surface that can be detected during the oxidation scan. The additional defined peak in the oxidation stage is associated to the H_{ads} oxidation produced during the HER. To evaluate nitrate reduction by H_{ads}, experiments were evaluated in the presence of tert-butyl alcohol (TBA) as a scavenger of H_{ads}. The presence of TBA decreased the nitrate removal (C/C₀) from 86.7% to 54% and 48% in presence of 200 mmol L⁻¹ TBA (pH=4.9) and 400 mmol L⁻¹ TBA (pH=4.4), respectively. The decrease in nitrate removal shows the indirect mechanism due at least in part to H_{ads} in the electrode surface that may be responsible for ˜36% of the nitrate conversion. Ni/Cu₂O and Ni/Cu₂O/Co(OH)ₓ were evaluated to identify the effect of Co sites over Cu₂O particles. The presence of Cu₂O suppresses the HER to more negative values. In the Ni/Cu₂O configuration no hydrogen adsorption peaks were observed during the forward scan after HER. The Ni/Cu₂O/Co(OH)ₓ adsorption zone was identified in the range from −0.5 to 0 V vs RHE.

While the Ni/Cu₂O electrodes were agnostic to the presence of H_{ads} scavenger TBA, the Ni/Cu₂O/Co(OH)ₓ showed a deterioration of performance. The Ni/Cu₂O configuration does not involve a co-existing catalytic hydrogenation mechanism. The H_{ads} contribution becomes evident when Co is introduced in the ternary nano-composite structure. The effect of TBA in ERN experiments showed a decrease in percentage removal from 90.4% to 63 and 54% with 200 and 400 mmol L⁻¹ TBA, respectively. The data suggest that an indirect reduction for trimetallic configuration can be responsible for ˜32% of overall nitrate conversion. The atomic hydrogen provision from HER can play a role during ammonia formation. The hypothesized mechanism of catalytic hydrogenation related to these results may follow the mechanism:

H₂O+e⁻→H_{(ads)}+OH⁻ (10)

NO_{3(ads)}⁻+2H_{(ads)}→NO_{2(ads)}⁻+H₂O (11)

NO_{2(ads)}⁻+H_{(ads)}→NO_{(ads)}+OH⁻ (12)

NO_{(ads)}+2H_{(ads)}→N_{(ads)}+H₂O (13)

N_{(ads)}+H_{(ads)}→NH_{(ads)} (14)

NH_{(ads)}+H_{(ads)}→NH_{2(ads)} (15)

NH_{2(ads)}+H_{(ads)}→NH_{3(ads)} (16)

The ammonia yield (mmol NH₃ g_{cat}⁻¹ h⁻¹) and FE for each electrode configuration after 2 h of treatment. The Ni/Cu₂O/Co(OH)ₓ electrode presented the highest ammonia yield with 1.22 mmol NH₃ g_{cat}⁻¹ h⁻¹ followed by Ni/Co(OH)ₓ with 1.10 mmol NH₃ g_{cat}⁻¹ h⁻¹. Lower ammonia yield values were obtained for Ni/Cu₂O and Ni electrodes with 0.21 and 0.13 mmol NH₃ g_{cat}⁻¹ h⁻¹, respectively. Ammonia yield (Y_{NH3}) of the trimetallic configuration was nine-fold higher than bare Ni foam with 1.22 and 0.13 mmol NH₃ g_{cat}⁻¹ h⁻¹. The maximum ammonia yield that was obtained from initial 30 mg NO₃⁻—N was 1.42 mmol g_{cat}⁻¹ h⁻¹. The FE for ammonia production values were calculated obtaining 2, 4, 20, and 22% for Ni, Ni/Cu₂O, Ni/Co(OH)ₓ, and Ni/Cu₂O/Co(OH)ₓ, respectively. The FE values consider both reduction pathways: direct electron transfer and catalytic hydrogenation. According to Equation (10), H_{ads} formation requires one electron transfer. From the proposed mechanism, ammonia formation by hydrogenation requires 8 H_{ads} which is equivalent to 8 electrons. To identify the relation between catalytic hydrogenation and current density, electrolysis experiments were conducted at different current densities. The ammonia production (mg NH₃—N L⁻¹) and FE after 2 h of treatment using Ni/Cu₂O/Co(OH)ₓ were calculated at 5, 10, 20, 30, and 40 mA cm⁻². A gradual increase of ammonia concentration from 4.2 mg L⁻¹ NH₃—N at 5 mA cm⁻² to 19.2 mg L⁻¹ NH₃—N at 20 mA cm⁻² was observed, which represents an increase in FE of ˜2-fold from 15% to 33%. At 30 mA cm⁻², ammonia production and FE slightly decreased down to 18.0 mg L⁻¹ NH₃—N and 20%, respectively. The decrease on the ammonia yield at 30 mA cm⁻² suggests that parallel reaction may begin to take place as a preferred reaction over nitrate reduction due at least in part to charge transfer. Further increase of j introduces a beneficial synergistic effect due at least in part to coexisting hydrogenation catalysis. Ammonia production at 40 mA cm⁻² surpassed the ammonia production obtained at 20 mA cm⁻², reaching up to 25.4 mg L NH₃—N. The increase in yield can be due at least in part to the enhancement of hydrogenation given the higher production and availability of H_{ads} as result of the acceleration of HER. The indirect electrochemical mechanism induced by strong reductant H_{ads} favors the higher production of ammonia. the product selectivity of catalytic hydrogenation can depend on the relative surface coverage of H_{ads} and N-species on the electrode surface. When the coverage of H_{ads} is higher, the reaction selectivity is preferentially steered towards ammonia formation. The overall FE holds the value of 20% that indicates that HER as parallel reaction has an impact on ammonia production. Table 3 summarizes the key parameters for ERN using different electrode configurations. The trimetallic electrocatalyst Ni/Cu₂O/Co(OH)ₓ outperforms the bimetallic structures in terms of ammonia yield and selectivity and decreases EE/O to a minimum value of 8 kWh L⁻¹ order⁻¹ (7-fold lower than Ni/Cu₂O and 1.4-fold lower than Ni/Co(OH)ₓ).

TABLE 3
Key parameters for ammonia production by ERN after 120 min of treatment time of 30 mg L⁻¹
NO₃⁻-N and 12.5 mmol L⁻¹ Na₂SO₄ at 40 mA cm⁻² for different electrode configurations

| | | | Nitrate | Y_{NH3} | | | EE/O |
|---|---|---|---|---|---|---|---|
| | K_{1-NO3} | K_{1-NO2} | conversion | (mmol NH₃ | S_{NH3} | FE | (kWh L⁻¹ |
| Electrode | (min⁻¹) | (min⁻¹) | (%) | g_{cat}⁻¹ h⁻¹) | (%) | (%) | order⁻¹) |
| Ni | 6 × 10⁻⁴ | 16 × 10⁻³ | 9.6 | 0.13 | 95.8 | 2 | 192 |
| Ni/Cu₂O | 3 × 10⁻³ | 13 × 10⁻³ | 28.4 | 0.21 | 49.5 | 4 | 58 |
| Ni/Co(OH)ₓ | 1 × 10⁻² | 56 × 10⁻³ | 86.7 | 1.10 | 87.5 | 20 | 11 |
| Ni/Cu₂O/Co(OH)ₓ | 2 × 10⁻² | 83 × 10⁻³ | 90.3 | 1.22 | 94.0 | 22 | 8 |

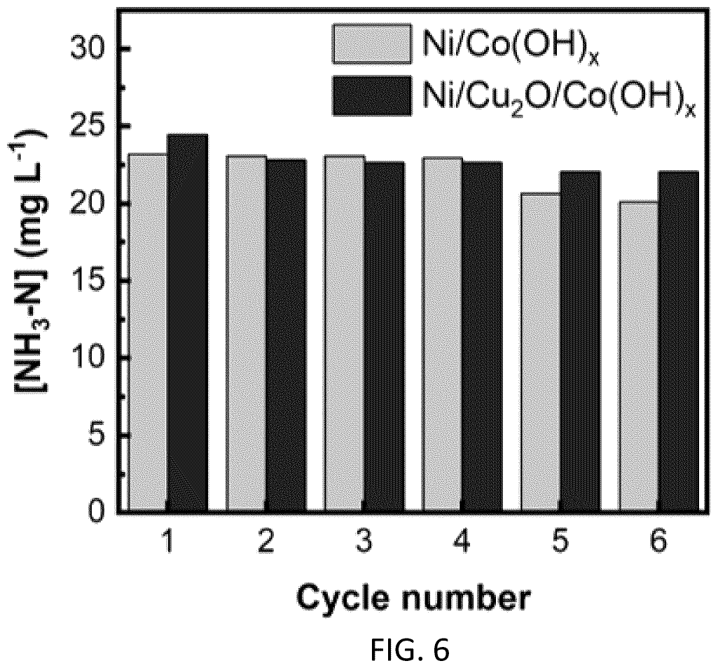

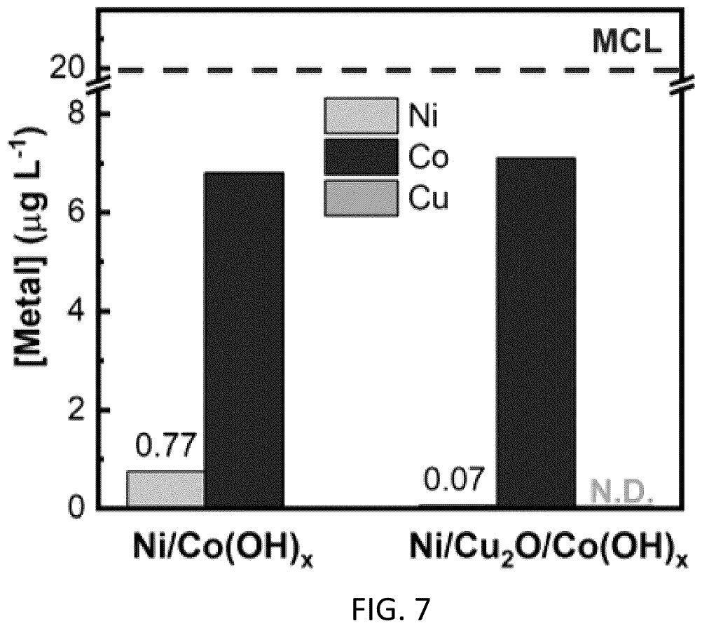

Metal-based electrocatalysts can have decreased stability and increased metal leaching during use. A stability evaluation was carried out using the same electrode after six times of continuous use with solution renewal each 2 h for a total of 12 h. As shown in FIG. 6, ammonia concentrations by Ni/Co(OH)ₓ and Ni/Cu₂O/Co(OH)ₓ in the first cycle were 23.2 and 24.5 mg L⁻¹ NH₃—N, respectively. After six consecutive cycles the ammonia obtained was 20.1 mg L⁻¹ NH₃—N for Ni/Co(OH)ₓ and 22.0 mg L⁻¹ NH₃—N for Ni/Cu₂O/Co(OH)ₓ. The activity retention or stability with respect to the first use corresponds to 86 and 90% for Ni/Co(OH)ₓ and Ni/Cu₂O/Co(OH)ₓ, respectively. The difference in the loss of activity is not statistically significant and suggests retention of the catalytic activity after sustained use of the electrocatalyst. In order to understand the loss of activity, metal leaching evaluation was determined by ICP-MS. FIG. 7 depicts the accumulation of metal leaching after six consecutive cycles of use. Nickel leaching concentration reached 0.77 and 0.07 μg L⁻¹ Ni for Ni/Co(OH)ₓ and Ni/Cu₂O/Co(OH)ₓ, respectively. The nickel leaching concentration values are negligible in comparison to the maximum contaminant level (MCL) of 100 μg L⁻¹ Ni. The cobalt leaching concentration reached statistically similar values of 6.8 and 7.0 μg L⁻¹ Co for bimetallic and trimetallic configurations, respectively. The MCL for Co is not an established value since the toxicity of this element depends on other environmental parameters, although the MCL presented by some studies is set around 20 μg L⁻¹ Co. Copper leaching was evaluated for the Ni/Cu₂O/Co(OH)ₓ electrode presenting a non-detectable (N.D.) concentration. The loss of activity can be attributed to the loss of Co sites in the electrode. Cu particles can participate in the Ni leaching that may be associated with the interaction Ni/Cu₂O obtained by electrodeposition. As Co(OH)ₓ demonstrated its role in the ERN, the loss of these composites can have an impact on the ammonia production presented in FIG. 6.

Electrodes based purely on earth-abundant elements with similar or competitive performance are required to diminish the gap in readiness technology. In this example, Ni foam was modified by low content of Cu and Co(OH)ₓ nanocomposites using electrodeposition as a green synthesis method. Ternary configuration Ni/Cu₂O/Co(OH)ₓ was evaluated in synthetic solution simulating an environmentally relevant nitrate concentration of 30 mg L⁻¹ NO₃⁻—N and 12.5 mmol L⁻¹ Na₂SO₄ under a current density of 40 mA cm⁻² within 2 h of treatment. Ni/Cu₂O/Co(OH)ₓ demonstrated an increased performance for ammonia production with 1.22 mmol NH₃ g_{cat}⁻¹ h⁻¹ in comparison to bare Ni foam (0.13 mmol NH₃ g_{cat}⁻¹ h⁻¹) and binary configuration Ni/Cu₂O (0.21 mmol NH₃ g_{cat}⁻¹ h⁻¹) and Ni/Co(OH)ₓ (1.10 mmol NH₃ g_{cat}⁻¹ h⁻¹). The disclosure presented herein demonstrated an increased performance for electrodes based on earth-abundant materials. The approach disclosed herein provides for materials that may produce a synergistic effect to surpass conventional performance of pure metal foams. The synergistic effect for the ternary configuration Ni/Cu₂O/Co(OH)ₓ can be explained as co-existing mechanisms including direct charge transfer and catalytic hydrogenation. Co(OH)ₓ sites show an atomic hydrogen provision (H_{ads}) which form part of the mechanism in nitrate reduction towards ammonia. Herein is experimentally demonstrated that the synergistic effect comes from nitrite formation by Cu nanoparticles and catalytic hydrogenation provided by Co(OH)ₓ which can be responsible for about 32% of ammonia produced.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composite catalyst comprising:
nickel foam; and
cobalt electrodeposited on the nickel foam, or
copper electrodeposited on the nickel foam, or
cobalt and copper electrodeposited on the nickel foam.

2. The composite catalyst of claim 1, wherein the cobalt is electrodeposited on the nickel foam, and is present as cobalt hydroxide nanoparticles.

3. The composite catalyst of claim 2, wherein the cobalt hydroxide nanoparticles have an average size between about 50 nm and about 100 nm.

4. The composite catalyst of claim 1, wherein the composite catalyst comprises about 1 wt % to about 10 wt % cobalt.

5. The composite catalyst of claim 1, wherein the copper is electrodeposited on the nickel foam, and the copper is present as copper oxide nanoparticles.

6. The composite catalyst of claim 5, wherein the copper oxide nanoparticles have an average size between about 500 nm and about 1000 nm.

7. The composite catalyst of claim 1, wherein the composite catalyst comprises about 1 wt % to about 10 wt % copper.

8. The composite catalyst of claim 1, wherein the cobalt is electrodeposited on the nickel foam and the copper is electrodeposited on the nickel foam.

9. The composite catalyst of claim 8, wherein the cobalt is present as a cobalt hydroxide and the copper is present as a copper oxide.

10. The composite catalyst of claim 9, wherein the composite catalyst comprises about 1 wt % to about 10 wt % cobalt and about 1 wt % to about 10 wt % copper.

11. The composite catalyst of claim 9, wherein at least some of the cobalt hydroxide nanoparticles are grown over some of the copper oxide nanoparticles.

12. The composite catalyst of claim 1, wherein the composite catalyst comprises about 85 wt % to about 95 wt % nickel.

13. A method of making the composite catalyst of claim 1, the method comprising:
contacting the nickel foam with an aqueous solution comprising copper, cobalt, or both; and
electrodepositing nanodomains of copper, cobalt, or both respectively, on the nickel foam.

14. The method of claim 13, wherein the electrodeposition is conducted by chronoamperometry.

15. The method of claim 13, wherein the chronoamperometry is conducted for a length of time between 1 minute and 5 minutes.

16. A method of electrochemically converting nitrate to ammonia, the method comprising:
contacting an electrode and a cathode in an electrochemical cell with an aqueous solution comprising nitrate, wherein the cathode comprises the composite catalyst of claim 1, wherein the cobalt and the copper are electrodeposited on the nickel foam;
adsorbing the nitrate onto the copper, the cobalt, or both;
reducing the nitrate to yield nitrite; and
reducing the nitrite to yield the ammonia.

17. The method of claim 16, wherein the conversion of nitrate exceeds 80% or 90%.

18. The method of claim 16, wherein a concentration of the nitrate in the aqueous solution is in a range of about 30 mg L⁻¹ NO₃⁻—N to about 200 mg L⁻¹ NO₃⁻—N.

19. The method of claim 16, wherein reducing the nitrate comprises galvanostatically reducing the nitrate.

20. The method of claim 16, wherein reducing the nitrate comprises catalytic hydrogenating the nitrite.
